(19) United States
(12) Patent Application Publication
(10) Pub. No.: US 2006/0151002 A1
(43) Pub. Date: Jul. 13, 2006

(54) Method of CVD chamber cleaning

(76) Inventor: Devendra Kumar, Los Altos Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/022,083

(22) Filed: Dec. 22, 2004

(51) Int. Cl. B08B 6/00; B08B 9/00; H05H 1/24

(52) U.S. Cl. 134/1.1; 134/22.1; 427/569

(57) ABSTRACT

A method for cleaning a plasma CVD reactor includes, during a cleaning cycle, (i) providing cleaning active species derived from a cleaning gas in the plasma CVD reactor, and (ii) generating a hydrogen plasma in an interior of the plasma CVD reactor to clean the interior of the reactor.

### BACKGROUND OF THE INVENTION

1. Field of the Invention

This invention relates generally to a method for cleaning a plasma CVD (chemical vapor deposition) reactor and a plasma CVD apparatus provided with a cleaning device.

2. Description of the Related Art

In a single-substrate- or small-batch substrate-processing apparatus, during CVD processing, a film is formed not only on a substrate but also on inner walls or other inner parts of a CVD chamber. The unwanted film on the inner parts of the chamber produces particles which deposit on a substrate during CVD processing and deteriorate the quality of a film on the substrate. Thus, the CVD chamber is cleaned periodically by using an in-situ cleaning process to remove unwanted adhesive products from an inner surface of the CVD chamber.

In conventional ULSI (ultra large scale integration) devices such as CPU, memory, and system LSI, an insulator formed between metal lines is typically silicon dioxide (USG) (SiH4-based SiO2 films or TEOS-based SiO2 films) or fluorine-containing silicon oxide (FSG). For Next generation micro devices, a reduction of the resistance of metal lines and a reduction of the capacitance of insulators between metal lines become more required. Cu is applied as a conductor instead of an aluminum alloy to reduce the resistance of metal lines, and a low-k dielectric film is used as an insulator instead of SiO2 and related materials. The low-k dielectric film that are used in 130 nm, 90 nm, and potential candidates for 65 nm, and 45 nm node interconnect technology. These films generally belong to CDO (carbon-doped oxide), also known as SiCOH, and these films are made of silicon, carbon, oxygen, and small or negligibe amount of hydrogen. The chemical composition of CDO films deposited by PECVD tool sets can be altered by selecting a proper deposition condition and therefore, it is possible to deposit CDO films of changing Si, C, O, and H composition. CDO low-k dielectric film is, in general, deposited by PECVD tool sets by selecting a precursor gas that is made of Si, O, C, and H. The dielectric constant of USG and FSG films is around 3.8 to 4.4. One of the trends for lowering the dielectric constant of the CDO film is to increase carbon content in the film. But as the carbon content is increasing so as the current cleaning processes need to be modified for efficient HVM cleaning.

As the device dimensions continuously shrink, the RC time delay of an interconnect system becomes one of the most critical limiting factors to integrated circuits performance. The RC delay is directly proportional to the resistivity of the metal and the dielectric constant of the dielectric used in the interconnect system. In order to minimize a signal propagation delay, it is inevitable to use low dielectric constant materials as inter-layer and intra-layer dielectrics (ILD). In a Dual Damascene interconnect structure, besides low-k ILDs, other dielectric films such as etch stop layers and copper barrier layers are also required. Silicon nitride (SiN) with a high dielectric constant (k>7.0) is still the primary candidate for ESL (etch stop layer) required in copper damascene structures. Thus, it is desirable to replace silicon nitride by new materials with lower dielectric constants to further reduce the effective dielectric constant of the Cu interconnect system. In recent years, an increasing interest has been focused on study of low stress and thermally stable low-k silicon carbide based films deposited by PECVD using organosilicon gases. The use of silicon carbide films as copper diffusion barrier layers has been published in U.S. Pat. No. 5,800,878. The dielectric constant of this film is about 5 or lower, and in addition, it is used as copper diffusion barrier layers for 130 nm/90/65/45 nm-nodes Large Scale Integration (LSI) technologies where the dielectric constant of the interlayer dielectric film is 3 to 2.4.

When pure or fluorine-doped SiO2 and SiN are deposited in a CVD reactor, sediment on inner surfaces of the CVD reactor can be removed by remote plasma cleaning. To reduce green house effect, NF3 gas is generally applied with remote plasma technology. In that case, Argon gas is added as a feedstock to stabilize plasma discharge in a remote plasma chamber isolated from the CVD reactor. This technology is disclosed in U.S. Pat. No. 6,187,691, and U.S. Patent Publication No. 2002/0011210A. The following references also disclose chamber cleaning technologies. U.S. Pat. No. 6,374,831, U.S. Pat. No. 6,387,207, U.S. Pat. No. 6,329,297, U.S. Pat. No. 6,271,148, U.S. Pat. No. 6,347,636, U.S. Pat. No. 6,187,691, U.S. Patent Publication No. 2002/0011210A, U.S. Pat. No. 6,352,945, and U.S. Pat. No. 6,383,955. The disclosure of the foregoing references is herein incorporated by reference in their entirety, especially with respect to configurations of a reactor and a remote plasma reactor, and general cleaning conditions.

The above conventional cleaning methods have problems explained below.

Low-k dielectric films used for ILDs contain Si, O, C, and H and are known as carbon doped oxide (CDO) or SiCO films. Silicon carbide films used as ESL include SiC, SiCN, SiCNH, SiCH, SiCOH, SiCO, and a sandwich of one of these films, etc. Next generation ILD films with lower dielectric constant (called ULK) and copper diffusion barrier films contain even higher percentages of carbon in SiCO structure. These carbon-containing films have slow cleaning rates when used with conventional cleaning methods using NF3, lowering throughput capacity of apparatus. On the other hands, in NF3 remote plasma cleaning, silicon nitride films and fluorine active species react each other at faster rates, and a cleaning rate of 2 microns/min. can be achieved for cleaning a reactor used for forming silicon nitride films (U.S. Patent Publication No. 2002/0011210A1, U.S. Pat. No. 5,788,778, and U.S. Pat. No. 6,374,831).

However, in the case of silicon oxide films, cleaning rates are approximately 1 to 1.5 microns/min.; cleaning rates of silicon carbide films and carbon rich silicon films are 0.08 to 0.2 microns/min. Such slow cleaning rates become the primary cause for lowering throughput capacity of apparatus.

### SUMMARY OF THE INVENTION

In the above, for example, when siloxan compounds are used as a precursor, such as divinyl dimethyl silane (DVDMS) and dimethyl dimethoxy silane (DMDMOS) separately or in combination, an unwanted reaction product accumulated on inner walls of the reactor contains Si, C, O, and H, and the use of NF3 remote plasma may take more than 10 minutes to clean the chamber walls. This is because while fluorine is interacting with the unwanted deposited film and removing them, a fluorine-containing thin film is depositing on the walls. The accumulation of a fluorine-containing composition on the walls during the cleaning process is surprising. For example, Thermal Extraction (TE) GC-Mass analyses show the presence of a fluorine-containing film.

In the present invention, by using a hydrogen plasma or hydrogen species-generated plasma and related precursors thereof in addition to cleaning using active species, the fluorine-containing film can be effectively removed. For example, SIMS profiles of a film show the effectiveness of the hydrogen plasma.

Objectives of the present invention are to provide a method enabling to clean products adhering to an inner surface of the CVD reactor at high rates; particularly, a method of speeding up rates of cleaning the inner surface of the CVD reactor used for forming carbon-containing films including silicon carbide films. Further, another objective is to provide a method having high throughput attributed to higher cleaning rates. By using a hydrogen plasma, the cleaning time can be reduced to 1-4 min. from 10 min. One or more embodiments of the present invention can achieve one or more of the above objects.

For purposes of summarizing the invention and the advantages achieved over the related art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 shows Thermal Extraction (TE) GC-Mass analysis of a film deposited on chamber parts (screws at 400° C.).

FIG. 2 shows Mass Spectrum of GC peak #1 of FIG. 1.

FIG. 3 shows Mass Spectrum of GC peak #2 of FIG. 1.

FIG. 4 shows Mass Spectrum of GC peak #3 of FIG. 1.

FIG. 5 shows Mass Spectrum of GC peak #4 of FIG. 1.

FIG. 6 shows Thermal Extraction (TE) GC-Mass analysis of a film deposited on a wafer (at 400° C.).

FIG. 7 shows Mass Spectrum of GC peak #1 of FIG. 6.

FIG. 8 shows Mass Spectrum of GC peak #2 of FIG. 6.

FIG. 9 shows Mass Spectrum of GC peak #3 of FIG. 6.

FIG. 10 shows Mass Spectrum of GC peak #3 of FIG. 6.

FIG. 11 shows SIMS Profiles of a film and a wafer before hydrogen plasma treatment.

FIG. 12 shows SIMS Profiles of a film and a wafer after hydrogen plasma treatment.

### DETAILED DESCRIPTION OF THE PREFERRED EMBODIMENT

In one aspect, the present invention provides a method for cleaning a plasma CVD reactor, comprising: during a cleaning cycle, (i) providing cleaning active species derived from a cleaning gas in the plasma CVD reactor, and (ii) generating a hydrogen plasma or reductive plasma in an interior of the plasma CVD reactor to clean the interior of the reactor. In the above, there is no limitation imposed on the configurations of the plasma CVD reactor. The devices disclosed in the references which are incorporated herein by reference can be used in the present invention in some embodiments.

In an embodiment, the hydrogen plasma or hydrogen active plasma is generated by introducing a gas containing hydrogen into the interior of the reactor, and exciting the gas using radio-frequency (RF) power. In the above, the RF power can be applied through an upper electrode and a lower electrode disposed in the interior of the reactor.

In another embodiment, the method may further comprise generating an oxygen plasma after the hydrogen plasma or hydrogen active plasma during the cleaning cycle. This is effective especially when a thin film deposited on an inner wall of the reactor contains carbon. An oxygen plasma efficiently etches carbon-containing compounds.

Step (ii) can be continuously conducted after step (i). Both steps (i) and (ii) may be conducted alternately in a cleaning cycle. Further, step (ii) can be conducted intermittently or in pulses during a cleaning process.

Preferably, the cleaning gas is excited in a remote plasma chamber and introduced into the interior of the reactor, so that the excitation process of the cleaning gas will not damage the inner parts of the reactor during a cleaning cycle. To be more efficient cleaning, the remote plasma chamber generates an inductively-coupled plasma to excite the cleaning gas.

The cleaning gas may comprise a fluorine-containing gas, and the active species may be fluorine active species. Fluorine active species are effective to react with silicon components. Further, if unwanted reaction products contain oxygen, such as silicon dioxide and siloxan polymer, and if the cleaning gas does not contain carbon, the cleaning gas may be a gas comprising fluorine (F2), nitrogen trifluoride (NF3), or a mixture of the foregoing without oxygen-containing gas or with a slight amount of oxygen-containing gas.

On the other hand, if unwanted reaction products contain no or very little oxygen, such as silicon nitride and silicon carbide, and if the cleaning gas contains carbon, such as a gas comprising a fluorocarbon compound (e.g., CF4, C2F6, COF2), an oxygen-containing gas may be added to the cleaning gas (in this case, the cleaning gas includes the oxygen-containing gas). Oxygen is effective to remove carbon components.

In the present invention, the cleaning rate is increased by applying electromagnetic waves to an inner surface of the reactor, and even if unwanted reaction products are carbon-containing films such as silicon carbide (SiC, SiCN, SiCO, SiCNH, SiCH, SiCOH, etc.), cleaning can be accomplished efficiently.

The present invention includes another aspect which is a method for cleaning substrates comprising: (i) processing multiple substrates using a single-substrate processing plasma CVD reactor, wherein a thin film enriched in carbon and containing C, H, O, and Si is formed on each substrate; and (ii) initiating a cleaning cycle by (i) providing cleaning active species derived from a cleaning gas in the plasma CVD reactor, and (ii) generating a hydrogen plasma or hydrogen active plasma in an interior of the plasma CVD reactor to clean the substrates. The cleaning technology can apply to not only a reactor but also wafers.

General conditions for cleaning are as follows:

1) A cleaning gas comprising: (1) a fluorine-containing gas (100-2000 sccm, including 200, 300, 500, 750, 1000, 1500 sccm, and any ranges between any two numbers of the foregoing); (2) an oxygen-containing gas (100-2000 sccm, including 200, 300, 500, 750, 1000, 1500 sccm, and any ranges between any two numbers of the foregoing); (3) an inert gas (0-2000 sccm, including 200, 400, 600, 1000, 1500 sccm, and any ranges between any two numbers of the foregoing). If no carbon components are present in the unwanted products or the cleaning gas, no oxygen is necessary.

2) Pressure of the reactor: 100-2000 Pa, including 200, 300, 500, 1000, 1500 Pa, and any ranges between any two numbers of the foregoing.

3) Temperature of the reactor (the temperature of a susceptor): 100-700° C., including 200, 300, 400, 500, 600° C., and any ranges between any two numbers of the foregoing.

4) The hydrogen plasma or hydrogen active plasma: RF power in the range of 100-2000 W (including 200, 300, 400, 500, 1,000, 1,500 W, and any ranges between any two numbers of the foregoing), with a gas containing hydrogen such as H2, NH3, H2O, H2O2 at a flow rate of 0 to 1500 sccm (including 50, 100, 400, 600, 1000 sccm, and any ranges between any two numbers of the foregoing) with and without diluent gases, such as N2, Ar, He, etc.

5) The ratio of a cleaning period of using cleaning active species (step (i)) to a cleaning period of using a hydrogen plasma or hydrogen active plasma (step (ii)): 1:9 to 9:1 (including 2:8, 3:7, 4:6, 5:5, 6:4, 7:3, 8:2, and including any ranges between any two numbers of the foregoing).

6) The cleaning rate: 300-3000 nm/min, including 400, 500, 750, 1000, 1500, 2000 nm/min, and any ranges between any two numbers of the foregoing. The cleaning rate can be regulated as a function of power of intensity and duration of hydrogen plasma or hydrogen active plasma. The cleaning period can be determined based on the thickness of unwanted products.

Step (ii) can be conducted continuously after step (i), i.e., the pressure of the reactor remains the same (without breaking a vacuum). Further, a hydrogen plasma or hydrogen active plasma can be generated in a remote plasma chamber.

An oxygen plasma can be conducted after the hydrogen plasma or hydrogen active plasma or alternately with the hydrogen plasma. The conditions for the oxygen plasma can be similar to those for the hydrogen plasma or hydrogen active plasma except that different types of gas is used, which contains oxygen such as O2, N2O, NO2, H2O, H2O2, etc.

In another aspect, the present invention provides a method for manufacturing multiple substrates having films deposited thereon, comprising the steps of: (I) treating multiple substrates using a single-substrate processing plasma CVD reactor, wherein a thin film is formed on each substrate; and (II) initiating a cleaning cycle by (i) providing cleaning active species derived from a cleaning gas in the plasma CVD reactor, and (ii) generating a hydrogen plasma or hydrogen active plasma in an interior of the plasma CVD reactor to clean the interior of the reactor.

In an embodiment, the thin film is a silicon carbide film, a carbon-doped silicon oxide film, a siloxan polymer or an organic polymer containing C, H, O, and/or Si, such as benzocyclobutene (BCB), or an organo-silicate. In the above, the cleaning gas includes oxygen and/or the cleaning further comprise generating an oxygen plasma after the hydrogen plasma or hydrogen active plasma.

The invention will be explained further with reference to specific embodiments, but the invention should not be limited thereto.

After conducting NF3 remote plasma cleaning, a film was formed on a φ300 mm wafer using DVDMS and DMDMOS using Eagle™-12 (ASM Japan in Tokyo). Thereafter, a film on the wafer and a chamber parts (screws) were subjected to TE-GC Mass analysis.

The chamber parts (screws) and the film on the wafer were heated at 400° C. over a 15 minutes in helium purge flow. The extracted compounds were collected in site on a cryotrap at −125° C. and injected internally and directly onto an attached GC column for separation of the components. The separated compounds were analyzed by Mass Spectrometer (MS) for fragmentation, identification, and characterization of each GC separated component.

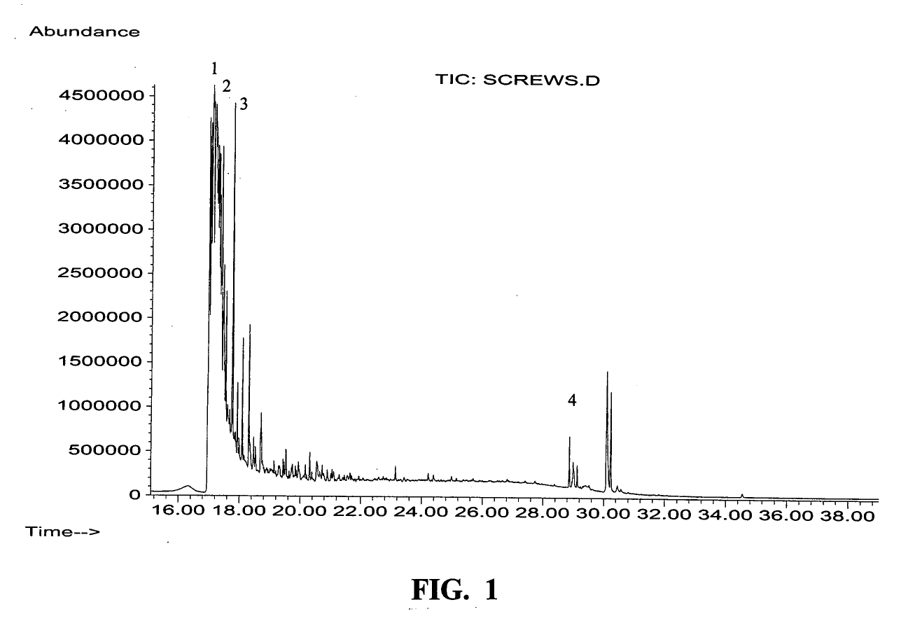

FIG. 1 shows Thermal Extraction (TE) GC-Mass analysis of a film deposited on chamber parts (screws). This shows a very large out-gassing in the form of multiple cluster peaks. Mass spectrum analyses were conducted on peaks #1 to #4 indicated.

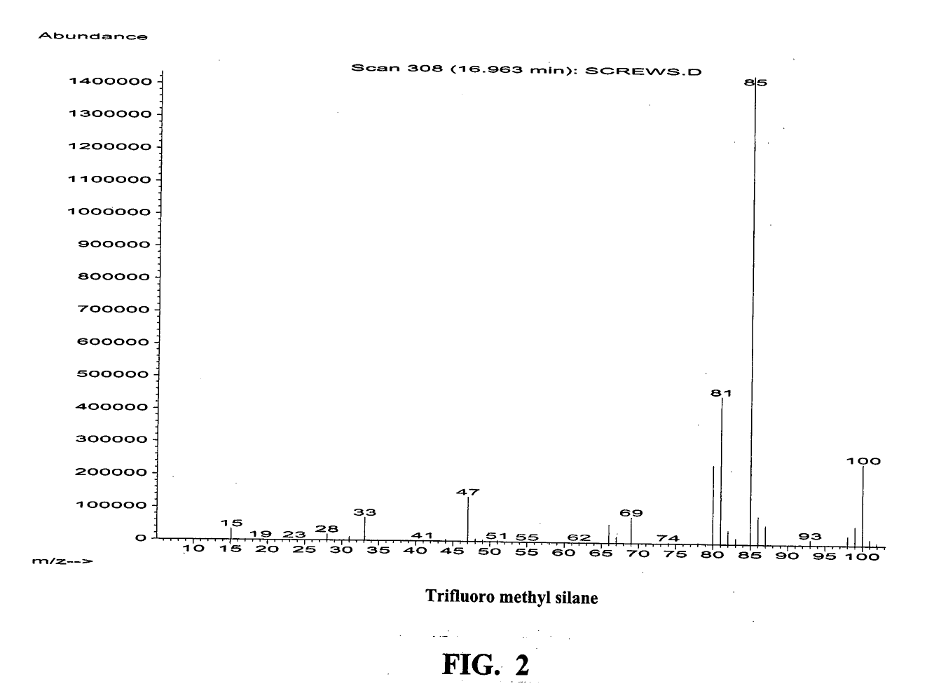

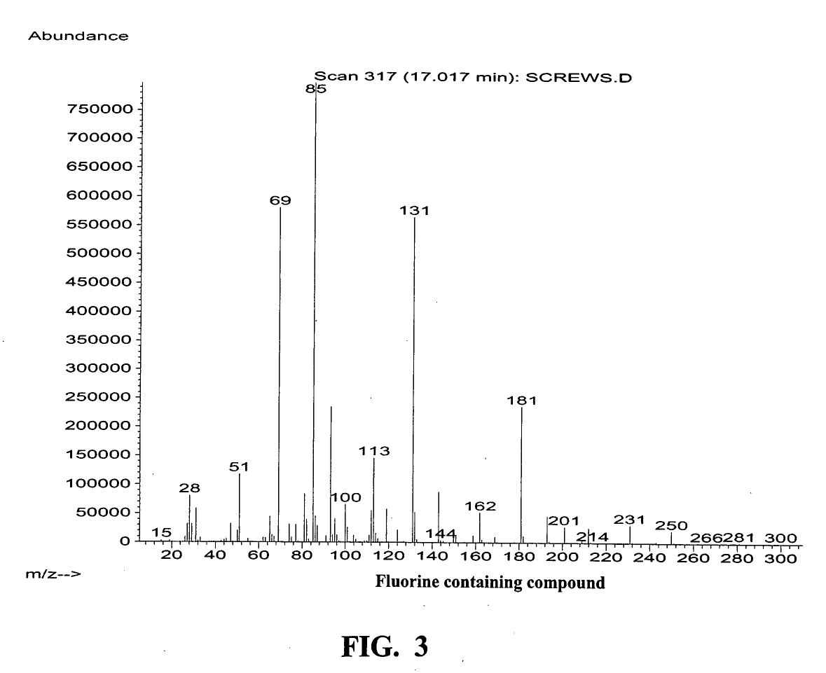

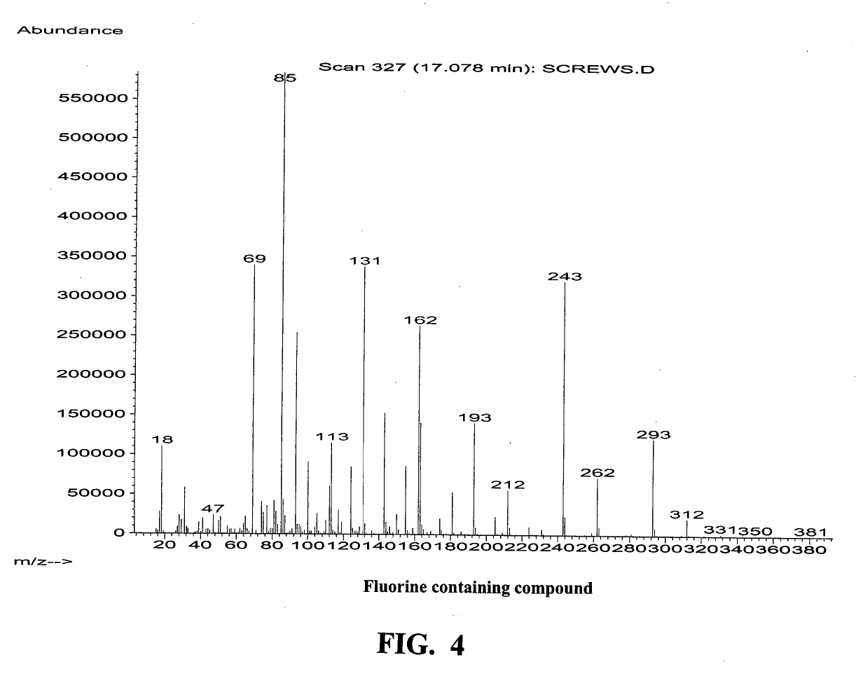

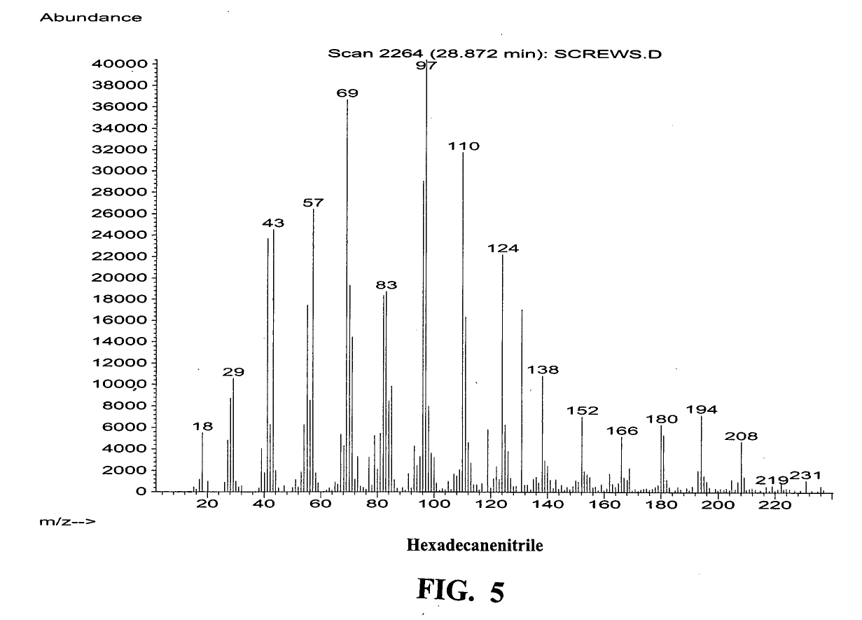

As shown in FIGS. 2-4, Mass Spectrum of GC peaks #1 to #3 show mass ion fragmentation indicative of fluorine-containing compounds. GC peak #1 shows mass spectral fragmentation with mass ions at m/z 100, 85, 81, 47, and 33. Selection of these mass ions was performed. Based on this mass fragmentation pattern, the compound would be identified as trifluoromethylsilane.

Selection of common mass ions for fluorine and silicon containing mass ion fragmentation were performed. Following mass ions were selected based on the observed data: Mass ion m/z 19 for F; Mass ion m/z 47 for SiF; Mass ion m/z 66 for SiF2; Mass ion m/z 85 for SiF3; Mass ion m/z 104 for SiF4. The selected mass ions chromatogram shows a very large out-gassing of mass ion at m/z 85 indicating out-gassing of tetraflurosilane or another similar compounds.

Mass spectrum of GC peak #4 shows a pattern indicative of hydrocarbons. This compound would be identified as hexadecanenitrile, indicating the presence of nitrogen in the film.

In conclusion, the film deposited on an inner walls (screws) contains fluorine which was not contained in the reaction gas but was contained in the cleaning gas. Thus, fluorine is likely to react with the film deposited on the wall and deposits thereon.

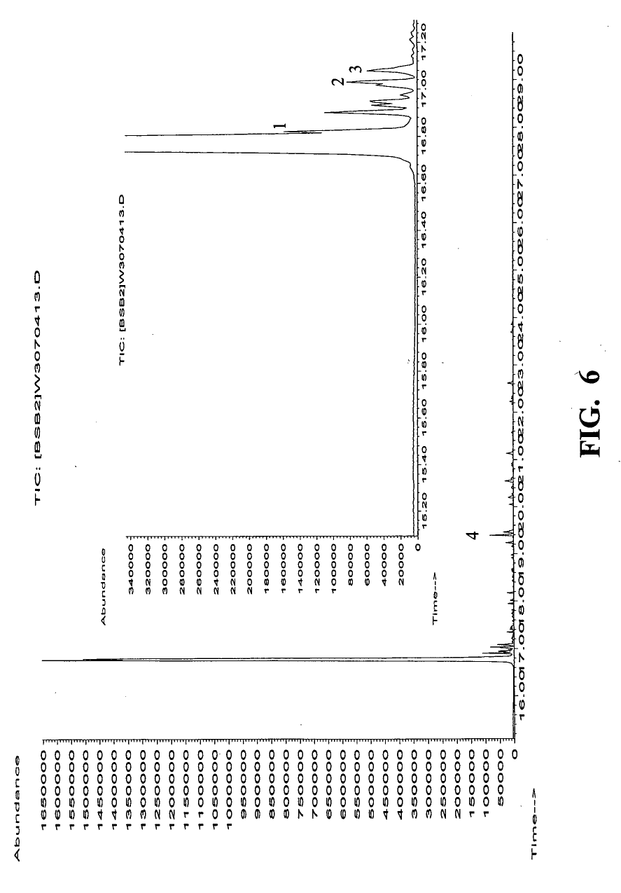

FIG. 6 shows Thermal Extraction (TE) GC-Mass analysis of a film deposited on a wafer. TE GC-Mass analysis of the film shows small out-gassing relative to the chamber parts (screws). Mss spectrum analysis was conducted on peaks #1 to #3 and indicates the presence of carbon, silicon, and hydrogen in the film.

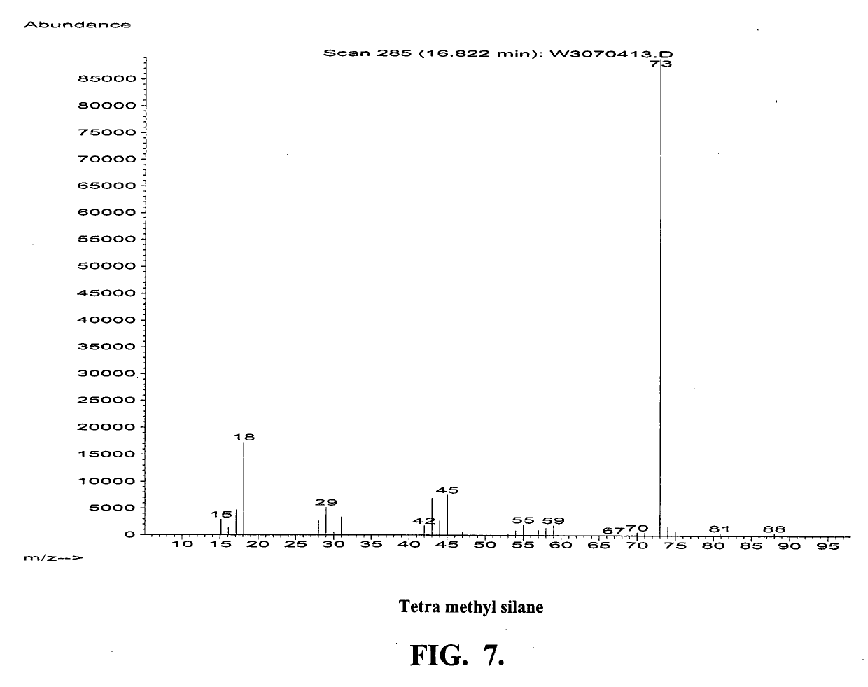

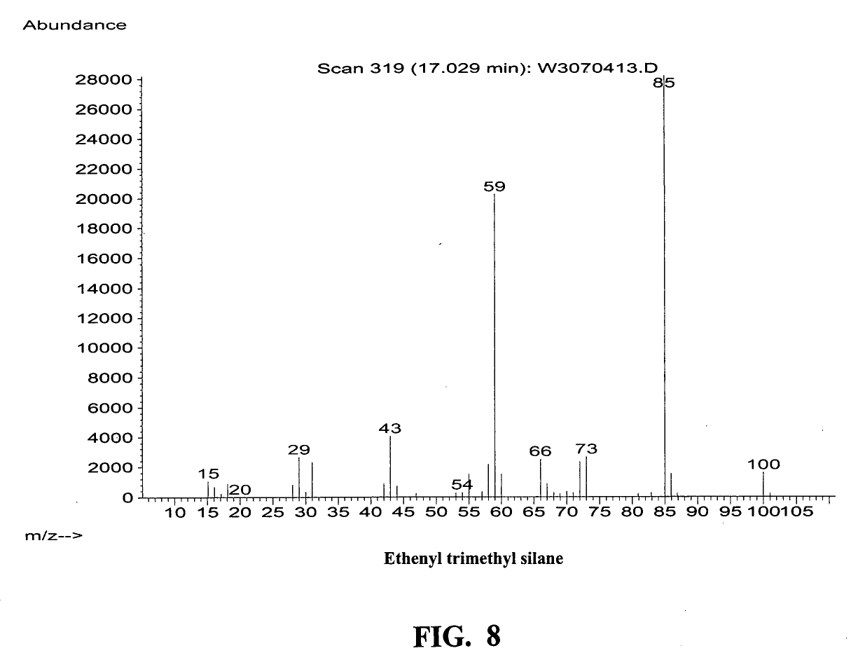

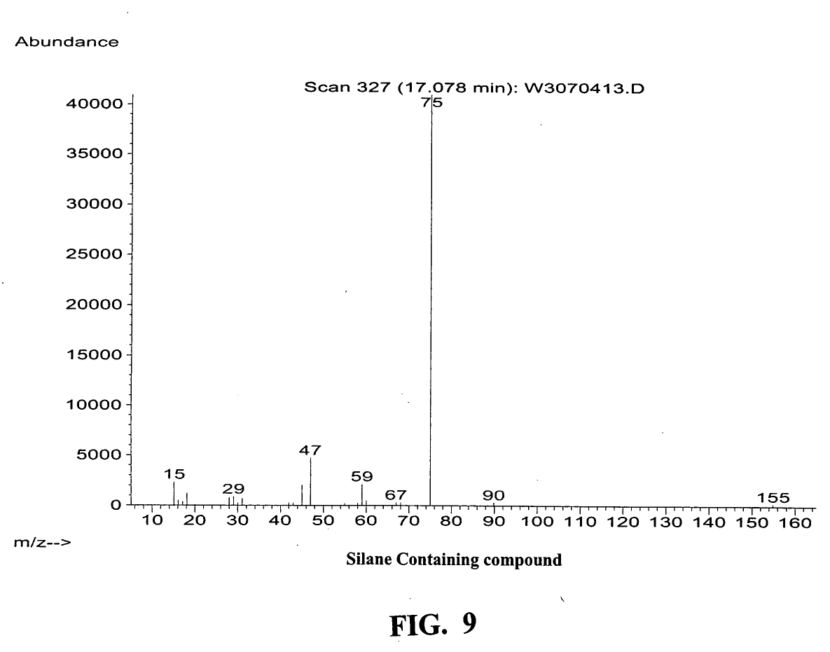

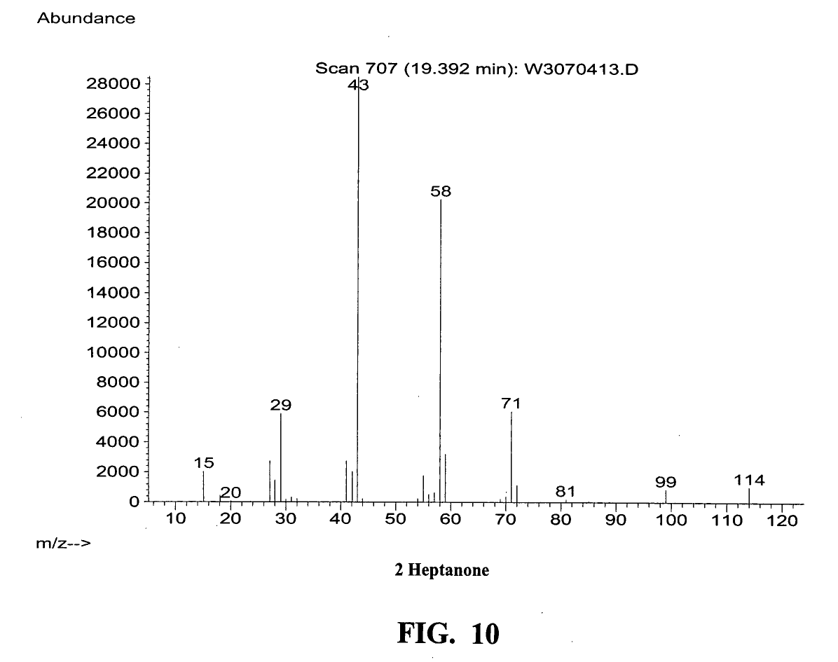

As shown in FIGS. 7-10, GC peak #1 shows mass spectrum indicative of silicon-containing compound which would be identified as tetramethysilane. GC peak #2 shows the presence of an unsaturated silicon-containing compound which would be identified as ethyenyltrimethylsilane. GC peak #3 shows the presence of m/z 75 as a base peak indicative of silicon-containing compound.

Thus, the film on the wafer did not contain fluorine, whereas the film on the walls (screws) contained fluorine. This clearly shows that the fluorine present in the film on the walls originated in the cleaning gas and accumulated on the walls (the screws were exposed to the cleaning active species whereas the wafers were not exposed thereto). During a cleaning cycle, an unwanted reaction product can be removed using a cleaning gas; however, on the other hand, a fluorine-containing thin film is forming on the walls.

Next, after conducting the NF3 remote plasma cleaning, hydrogen plasma treatment was initiated.

While conducting the hydrogen plasma cleaning, a wafer on which a film was formed was left on a susceptor (under normal conditions, no wafer is placed on the susceptor during cleaning).

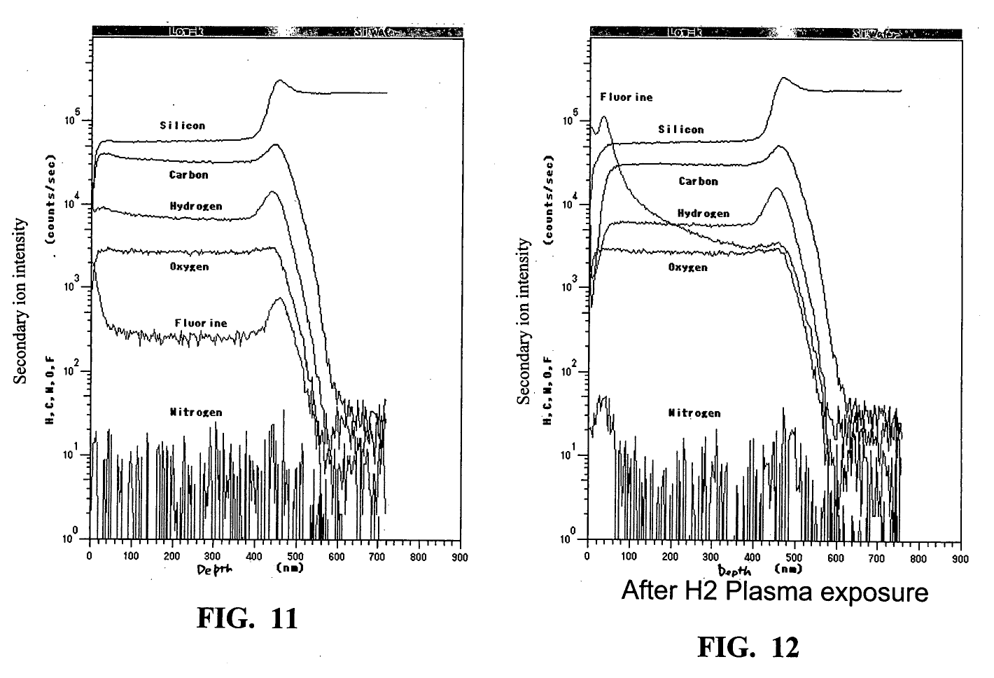

FIG. 11 shows SIMS Profiles of a film and a wafer before hydrogen plasma treatment. FIG. 12 shows SIMS Profiles of a film and a wafer after hydrogen plasma treatment. As clearly shown in these figures, the fluorine concentration significantly increased on the surface of the film. This increase must be the result of the hydrogen plasma cleaning which removed fluorine present in the film deposited on the walls. This shows that hydrogen plasma treatment is very effective to remove a fluorine-containing film deposited on the chamber walls. Accordingly, by using a combination of cleaning by cleaning active species and cleaning by hydrogen plasma treatment, a film containing Si, C, O, H, and F, deposited on inner walls, can be effectively removed.

In an embodiment, a thin-film deposition apparatus forming a thin film onto a substrate, comprises a reactor for storing the substrate and for forming a thin film onto the substrate, and a remote plasma chamber for activating a cleaning gas used for removing reaction product adhering to an inner surface of the reactor during thin-film deposition onto the substrate.

After a carbon-containing silicon oxide film or a silicon carbide film, for example, is deposited onto the substrate inside the reactor, the substrate is brought out from the reactor.

A cleaning gas containing fluorine is introduced into the remote plasma chamber at a given flow rate; plasma discharge is formed inside the remote plasma chamber; the cleaning gas is activated; activated cleaning gas (i.e., “cleaning active species”) is introduced into the reactor. Next, hydrogen plasma treatment is initiated.

The reaction products adhering to an inner surface of the reactor absorb electromagnetic waves, are heated, changed into a gas by the cleaning active species, and evacuated from the reactor.

If a film deposited onto the substrate is a silicon carbide film (having Si, C, H or Si, C, N, H or Si, C, O, H as it components), a mixed gas of NF3, oxygen and inert gas is used as a cleaning gas. COF2, C2F6, C3F8, C4F8, CF4 and oxygen-containing gas (e.g. oxygen, CO2, O3, NO2, N2O, CO, H20, NOF, H2O2) can also be used as a cleaning gas. Additionally, F2, and F2 and inert gas or oxygen, or nitrogen, or a mixed gas with NF3, a mixed gas of F2 and oxygen-containing gas can also be used as a cleaning gas.

If a thin film deposited onto the substrate is a film containing a high percentage of oxygen, an amount of oxygen-containing gas in a cleaning gas can be reduced; if a film does not contain carbon such as a silicon nitride film or a silicon oxide film, an amount of oxygen-containing gas can be reduced to zero if F2 or NF3 is used as a cleaning gas. If a cleaning gas itself contains carbon such as CF4, C2F6 or COF2, an oxygen-containing gas is used by mixing it with a cleaning gas to prevent carbon from remaining inside the reactor, or a carbon film or carbon particles from remaining inside the reactor or the remote plasma chamber. Particularly, an oxygen-containing gas is effective to prevent carbon components from remaining inside the reactor or the remote plasma chamber. When a carbon-containing thin film is deposited onto the substrate, an oxygen-containing gas is introduced into the remote plasma chamber with a fluorine-containing gas, which is a cleaning gas.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method for cleaning a plasma CVD reactor, comprising:
during a cleaning cycle, (i) providing cleaning active species derived from a cleaning gas in the plasma CVD reactor, and (ii) generating a hydrogen plasma or hydrogen active plasma in an interior of the plasma CVD reactor to clean the interior of the reactor.

2. The method according to claim 1, wherein the hydrogen plasma or hydrogen active plasma is generated by introducing a gas containing hydrogen into the interior of the reactor, and exciting the gas using radio-frequency (RF) power.

3. The method according to claim 2, wherein the RF power is applied through an upper electrode and a lower electrode disposed in the interior of the reactor.

4. The method according to claim 1, further comprising generating an oxygen plasma after the hydrogen plasma or hydrogen active plasma during the cleaning cycle.

5. The method according to claim 1, wherein the cleaning gas is excited in a remote plasma chamber and introduced into the interior of the reactor.

6. The method according to claim 1, wherein the cleaning gas comprises a fluorine-containing gas.

7. The method according to claim 1, wherein the cleaning gas comprises fluorine, fluorine trinitride, or a mixture of the foregoing.

8. The method according to claim 1, wherein the cleaning gas comprises a fluorocarbon compound and an oxygen-containing gas.

9. The method according to claim 1, wherein the cleaning gas comprises NF3.

10. The method according to claim 1, wherein step (ii) is conducted continuously after step (i).

11. The method according to claim 1, wherein the cleaning active species are generated by an inductively-coupled plasma produced in a remote plasma chamber.

12. A method for manufacturing multiple substrates having films deposited thereon, comprising:
treating multiple substrates using a single-substrate processing plasma CVD reactor, wherein a thin film is formed on each substrate; and
initiating a cleaning cycle by (i) providing cleaning active species derived from a cleaning gas in the plasma CVD reactor, and (ii) generating a hydrogen plasma or hydrogen active plasma in an interior of the plasma CVD reactor to clean the interior of the reactor.

13. The method according to claim 12, wherein the thin film is a silicon carbide film, a carbon-doped silicon oxide film, a siloxan polymer or an organic polymer containing C, H, O, and/or Si, or an organo-silicate.

14. The method according to claim 13, wherein the organic polymer is benzocyclobutene (BCB).

15. The method according to claim 13, wherein the cleaning gas includes oxygen.

16. The method according to claim 13, further comprising generating an oxygen plasma after the hydrogen plasma or hydrogen active plasma.

17. A method for cleaning substrates comprising:
processing multiple substrates using a single-substrate processing plasma CVD reactor, wherein a thin film enriched in carbon and containing C, H, O, and Si is formed on each substrate; and
initiating a cleaning cycle by (i) providing cleaning active species derived from a cleaning gas in the plasma CVD reactor, and (ii) generating a hydrogen plasma or hydrogen active plasma in an interior of the plasma CVD reactor to clean the substrates.

18. The method according to claim 17, wherein the thin film is a silicon carbide film, a carbon-doped silicon oxide film, a siloxan polymer or an organic polymer containing C, H, O, and Si, or an organo-silicate.

19. The method according to claim 17, wherein the cleaning gas includes oxygen.

20. The method according to claim 17, further comprising generating an oxygen plasma after the hydrogen plasma or hydrogen active plasma.
